(19) United States
(12) Patent Application Publication
(10) Pub. No.: US 2026/0237780 A1
(43) Pub. Date: Aug. 13, 2026

(54) ANISOTROPIC THERMAL CONDUCTIVITY LAYER FOR A BATTERY CELL GROUP ASSEMBLY

(71) Applicant: GM Global Technology Operations LLC, Detroit, MI (US)

(72) Inventors: Xiaoling Chen, Sterling Heights, MI (US); Jian Zhang, Rochester Hills, MI (US); Yifan Zhou, Rochester Hills, MI (US); William Yu Chen, Troy, MI (US); Diptak Bhattacharya, Royal Oak, MI (US); Derek Frei Lahr, Ann Arbor, MI (US); Xianfeng Yan, Clawson, MI (US); Nikhil Mone, Rochester Hills, MI (US); Ryan Patrick Hickey, Austin, TX (US); Ziliang Zheng, Auburn Hills, MI (US)

(73) Assignee: GM Global Technology Operations LLC, Detroit, MI (US)

(21) Appl. No.: 19/049,036

(22) Filed: Feb. 10, 2025

(51) Int. Cl. H01M 10/653; H01M 10/613; H01M 10/6555

(52) U.S. Cl. CPC H01M 10/653; H01M 10/613; H01M 10/6555; H01M 2220/20

(57) ABSTRACT

A battery cell group assembly includes a cooling plate, one or more battery cells operably coupled to the cooling plate, and one or more thermal insulators disposed between the one or more battery cells. The battery cell group assembly also includes an anisotropic thermal conductivity layer operably coupled to the one or more battery cells and the one or more thermal insulators. The anisotropic thermal conductivity layer is configured to redirect heat from the one or more battery cells to the cooling plate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a graphite layer for a battery cell group assembly.

Vehicles may be equipped with battery cell packs that are grouped within a shell. For example, battery cell packs may have a housing in which one or more battery cells may be disposed. Battery cell packs also typically include a cooling plate or other cooling mechanism configured to draw heat away from the battery cells. The battery cells are generally insulated from each other using foam or other insulating materials to reduce heat transfer between the cells, thereby aiding in thermal management.

### SUMMARY

In some aspects, a battery cell group assembly includes a cooling plate, one or more battery cells operably coupled to the cooling plate, and one or more thermal insulators disposed between the one or more battery cells. The battery cell group assembly also includes an anisotropic thermal conductivity layer operably coupled to the one or more battery cells and the one or more thermal insulators. The anisotropic thermal conductivity layer is configured to redirect heat from the one or more battery cells to the cooling plate.

In some examples, the anisotropic thermal conductivity layer may be directly coupled with the cooling plate and indirectly coupled to the one or more battery cells. Optionally, the anisotropic thermal conductivity layer may be disposed between a battery cell of the one or more battery cells and a thermal insulator of the one or more thermal insulators. The anisotropic thermal conductivity layer may be disposed around the thermal insulator. In some instances, the cooling plate may be a cooling ribbon wound between adjacent battery cells of the one or more battery cells and the anisotropic thermal conductivity layer may be coupled to the cooling ribbon between the adjacent battery cells. The battery cell group assembly may also include a housing that may include a plurality of plates, the one or more battery cells disposed within the housing. In this configuration, the anisotropic thermal conductivity layer may be coupled to the housing. Optionally, the anisotropic thermal conductivity layer may include a first anisotropic thermal conductivity layer and a second anisotropic thermal conductivity layer. The first anisotropic thermal conductivity layer may be coupled to a first panel of the plurality of panels of the housing and the second anisotropic thermal conductivity layer may be coupled to a second panel of the plurality of panels of the housing. The anisotropic thermal conductivity layer may include an in-plane conductivity of at least 800 watts per meter kelvin (W/mK).

In other aspects, a battery cell group assembly for a vehicle includes a cooling plate, one or more battery cells operably coupled to the cooling plate, and one or more thermal insulators disposed between the one or more battery cells. The battery cell group assembly also includes a graphite layer operably coupled to the one or more battery cells. The graphite layer includes an in-plane conductivity of at least 800 watts per meter kelvin and is configured to redirect heat from the one or more battery cells to the cooling plate.

In some examples, the graphite layer may be directly coupled with the cooling plate and indirectly coupled to the one or more battery cells. Optionally, the graphite layer may be disposed between a battery cell of the one or more battery cells and a thermal insulator of the one or more thermal insulators. The graphite layer may be disposed around the thermal insulator. In some configurations, the cooling plate may be a cooling ribbon wound between adjacent battery cells of the one or more battery cells and the graphite layer may be coupled to the cooling ribbon between the adjacent battery cells. The battery cell group assembly may also include a housing having a plurality of plates, and the one or more battery cells may be disposed within the housing and the graphite layer may be coupled to the housing.

In some instances, the graphite layer may include a first graphite layer and a second graphite layer. The first graphite layer may be coupled to a first panel of the plurality of panels of the housing and the second graphite layer may be coupled to a second panel of the plurality of panels of the housing. The battery cell group assembly may also include a thermal interface material coupled to the cooling plate beneath the one or more battery cells. The graphite layer may be disposed between the thermal interface material and the cooling plate.

In further aspects, a battery cell group assembly for a vehicle includes a cooling plate, one or more battery cells operably coupled to the cooling plate, and a thermal interface material coupled to the cooling plate beneath the one or more battery cells. The battery cell group assembly also includes one or more thermal insulators disposed between the one or more battery cells and operably coupled to the one or more battery cells and the thermal interface material. The battery cell group assembly further includes a graphite layer operably coupled to the thermal interface material and the cooling plate and indirectly operably coupled to the one or more battery cells. The graphite layer includes an in-plane conductivity of at least 800 watts per meter kelvin (W/mK) and is configured to redirect heat from the one or more battery cells to the cooling plate.

In some examples, the in-plane conductivity of the graphite layer may be approximately 1200 W/mK. Optionally, the in-plane conductivity of the graphite layer may be approximately 1500 W/mK. In some instances, the graphite layer may have a through-plane conductivity of less than twenty (20) W/mK.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle equipped with a battery cell group assembly according to the present disclosure;

FIG. 2 is a perspective view of a battery cell group assembly according to the present disclosure;

FIG. 3 is an elevational view of a battery cell group assembly according to the present disclosure, the battery cell group assembly including a graphite layer positioned beneath battery cells;

FIG. 4 is a top view of a battery cell group assembly according to the present disclosure, the battery cell group assembly including a graphite layer wound between battery cells;

FIG. 5 is an elevational view of a battery cell group assembly according to the present disclosure, the battery cell group assembly including a graphite layer disposed around thermal insulators;

FIG. 6A is a cross-sectional view of a housing for a battery cell group assembly according to the present disclosure, the battery cell group assembly including a first graphite layer along a top portion of battery cells and a second graphite layer along a bottom portion of the battery cells;

FIG. 6B is a partial view of the battery cell group assembly of FIG. 6A; and

FIG. 7 is an exemplary graph of property limits for a graphite layer for a battery cell group assembly according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

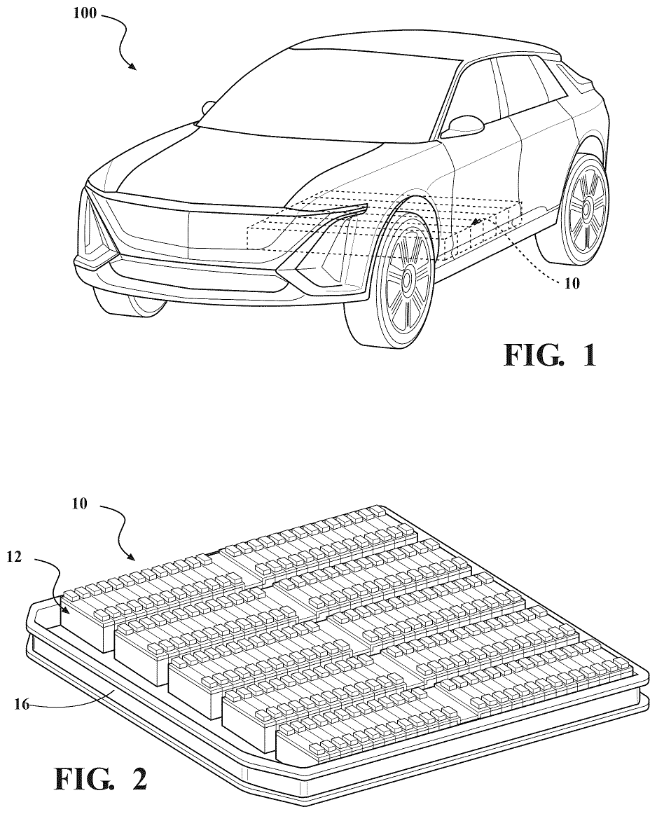

Referring to FIGS. 1-3, a vehicle 100 includes a battery cell group assembly 10. For example, the vehicle 100 may be configured as an electric vehicle (EV) and/or a hybrid-electric vehicle. The battery cell group assembly 10 may have various configurations, described herein, and includes one or more battery cells 12 arranged with one or more thermal insulators 14. The thermal insulators 14 are interspersed with the battery cells 12 and are configured to buffer heat dissipated by the battery cells 12 during operation of the battery cell group assembly 10. The thermal insulators 14 may be a foam, aerogel, or any other practicable insulation material. The thermal insulator 14 generally prevents a minimum heat exchange between adjacent battery cells 12.

The battery cell group assembly 10 also includes a cooling plate 16 disposed beneath the battery cells 12 and the thermal insulators 14. The cooling plate 16 is configured to absorb or otherwise receive dissipated heat from the battery cells 12 and provide a cooling function for the battery cell group assembly 10. The cooling plate 16 is configured to have coolant run along and/or within the cooling plate 16 to generate a cooling effect along the cooling plate 16. In some configurations, a thermal interface material 18 may be positioned between the battery cells 12, the thermal insulators 14, and the cooling plate 16 to further draw the dissipated heat from the battery cells 12. The thermal interface material 18 may be configured to fill a gap between the cooling plate 16 and the battery cells 12 to avoid direct metal-on-metal contact and reduce thermal resistance. For example, the thermal interface material 18 may include, but is not limited to, silicon.

With further reference to FIGS. 1-3, the battery cell group assembly 10 further includes an anisotropic thermal conductivity layer 20 that is configured to draw the dissipated heat from the battery cells 12. For example, the anisotropic thermal conductivity layer 20 may be formed of graphite. The anisotropic thermal conductivity layer 20 has properties of high in-plane thermal conductivity 22 and low through-plane conductivity 24, described in more detail below. During operation, one or more of the battery cells 12 may experience a heating event that causes the respective battery cell 12 to overheat. The thermal insulators 14 may provide a buffer between adjacent battery cells 12 during a heating event to minimize heat transfer between the battery cells. The anisotropic thermal conductivity layer 20 is configured to draw the expelled heat away from adjacent battery cells 12 and toward the cooling plate 16 via the high in-plane thermal conductivity 22.

The anisotropic thermal conductivity layer 20 has a high thermal conductivity, such that the heat transfer from the battery cell 12 is rapid. The anisotropic thermal conductivity layer 20 directs the heat downwards, away from the battery cells 12 and thermal insulators 14, towards the cooling plate 16. As a result, the anisotropic thermal conductivity layer 20 may help regulate a temperature of the battery cell group assembly 10 and minimize the potential for a thermal propagation event. The thermal propagation event may occur where the heating event is not contained or otherwise redirected away from adjacent battery cells 12. While the thermal insulators 14 provide the buffer between adjacent battery cells 12, the thermal insulator 14 may be insufficient to prevent a heating event, such as a thermal propagation event.

As mentioned above, the anisotropic thermal conductivity layer 20 has in-plane conductivity 22 and through-plane conductivity 24. The in-plane conductivity 22 is defined as the general thermal conductivity of the anisotropic thermal conductivity layer 20, and the through-plane conductivity 24 is defined as the directional thermal conductivity of the graphite layer 20. For example, the anisotropic thermal conductivity layer 20 is configured to redirect heat away from the battery cells 12 in an outward direction (i.e., away from the battery cells 12) along a length of the anisotropic thermal conductivity layer 20. The in-plane conductivity 22 of the anisotropic thermal conductivity layer 20 is greater than the through-plane conductivity 24, such that the anisotropic thermal conductivity layer 20 is configured to dissipate the heat generated by the battery cells 12 in-plane rather than through-plane.

For example, the in-plane conductivity 22 of the anisotropic thermal conductivity layer 20 is designed to be at least approximately 800 watts per meter kelvin (W/mK). However, the in-plane conductivity 22 may range from and between approximately 800 W/mK and approximately 1500 W/mK. For example, the in-plane conductivity 22 may be approximately 1200 W/mK. In comparison, the through-plane conductivity 24 may generally be less than twenty (20) W/mK. For example, the through-plane conductivity 24 may range from and between approximately fifteen (15) W/mK and eighteen (18) W/mK.

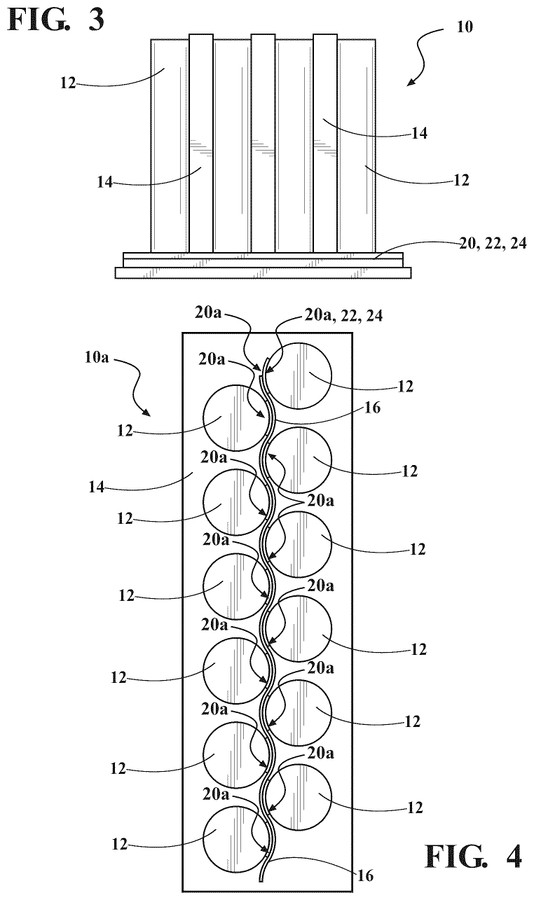

With specific reference to FIG. 3, the graphite layer 20 is illustrated as being directly coupled with the cooling plate 16 and indirectly coupled to the battery cells 12. For example, the anisotropic thermal conductivity layer 20 may be positioned between the cooling plate 16 and the thermal interface material 18 coupled to the cooling plate 16. The anisotropic thermal conductivity layer 20 has the high thermal conductivity that, despite being disposed between the thermal interface material 18 and the cooling plate 16, draws heat from the battery cells 12 away from the thermal insulators 14 and adjacent battery cells 12. The graphite layer 20 may be described as being indirectly coupled to the battery cells 12, as the graphite layer 20 is thermally coupled to the battery cells 12. The in-plane conductivity 22 of the anisotropic thermal conductivity layer 20 dissipates the heat from the battery cell(s) 12 along the anisotropic thermal conductivity layer 20, and the through-plane conductivity 24 of the anisotropic thermal conductivity layer 20 directs the heat towards the cooling plate 16.

Referring now to FIG. 4, a battery cell group assembly 10a is provided. In view of the substantial similarity in structure and function of the components associated with the battery cell group assembly 10, like reference numerals are used hereinafter and in the drawings to identify like components while like reference numerals containing letter extensions are used to identify those components that have been modified.

The battery cell group assembly 10a is illustrated with a cooling ribbon 16a. For example, the cooling ribbon 16a is wound between adjacent battery cells 12, and an anisotropic thermal conductivity layer 20a is coupled to the cooling ribbon 16a. The battery cells 12 may be positioned within a potting 14a, and the cooling ribbon 16a may be positioned down a center of the battery cell group assembly 10a. The anisotropic thermal conductivity layer 20a may be positioned at discrete positions along the cooling ribbon 16 to maximize the draw of heat from the battery cells 12 toward the cooling ribbon 16a. For example, an anisotropic thermal conductivity layer 20a may be positioned proximate to each battery cell 12 along the cooling ribbon 16a to draw heat generated by each battery cell 12 toward the cooling ribbon 16a. The ribbon configuration of the cooling ribbon 16a and the anisotropic thermal conductivity layer 20a enable rapid heat dissipation along a length of the anisotropic thermal conductivity layer 20a. As a result, the dissipation of the heat may have an improved uniformity, such that a uniform temperature may be defined among the battery cells 12.

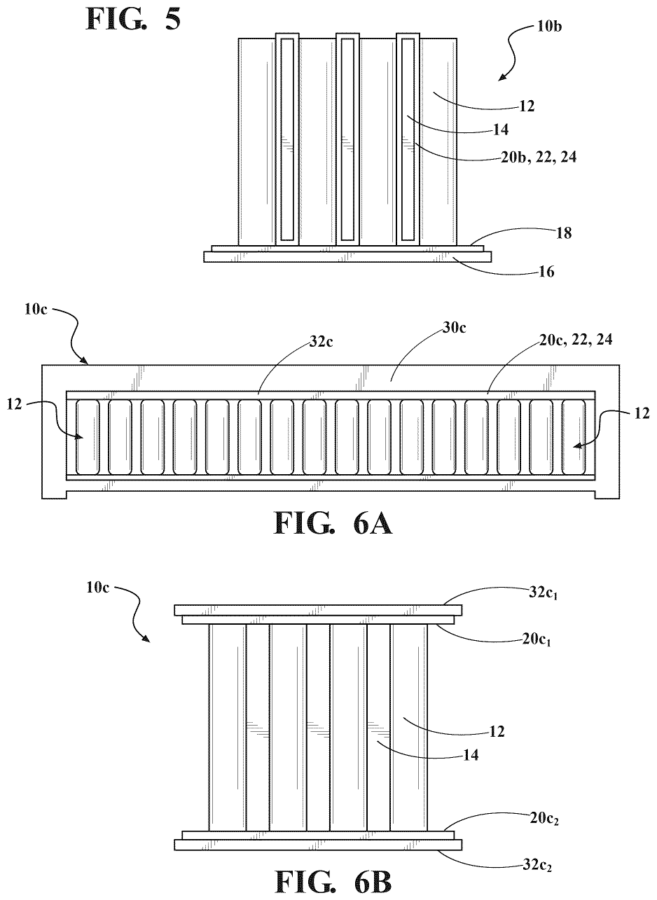

With specific reference to FIG. 5, a battery cell group assembly 10b is provided. In view of the substantial similarity in structure and function of the components associated with the battery cell group assembly 10, like reference numerals are used hereinafter and in the drawings to identify like components while like reference numerals containing letter extensions are used to identify those components that have been modified.

The battery cell group assembly 10b includes an anisotropic thermal conductivity layer 20b disposed around each of the thermal insulators 14. For example, the anisotropic thermal conductivity layer 20b is disposed between a battery cell 12 and an adjacent thermal insulator 14, such that the anisotropic thermal conductivity layer 20b separates the battery cell 12 from the thermal insulator 14. The anisotropic thermal conductivity layer 20b is disposed around the thermal insulator 14 to encase each thermal insulator 14 in an anisotropic thermal conductivity layer 20b. Additionally or alternatively, the anisotropic thermal conductivity layer 20b may be wrapped around each battery cell 12. As a result of the high in-plane thermal conductivity 22 of the anisotropic thermal conductivity layer 20b, heat generated by the battery cells 12 is drawn away from the thermal insulators 14 and redirected toward the cooling plate 16, as described above. In this configuration, the battery cell group assembly 10b may include the thermal interface material 18 between the battery cells 12, the anisotropic thermal conductivity layers 20b, and the cooling plate 16. The placement of the anisotropic thermal conductivity layer 20b around either the thermal insulator 14 and/or the battery cell 12 enhances the overall performance of the thermal insulator 14 by redirecting the heat from the battery cell 12.

Referring to FIGS. 6A and 6B, a battery cell group assembly 10c is provided. In view of the substantial similarity in structure and function of the components associated with the battery cell group assembly 10, like reference numerals are used hereinafter and in the drawings to identify like components while like reference numerals containing letter extensions are used to identify those components that have been modified.

The battery cell group assembly 10c includes a housing 30c having a plurality of panels 32c. The one or more battery cells 12 are disposed within the housing 30c with the thermal insulators 14 interspaced between the battery cells 12. The housing 30c is designed as a heat sink, such that the panels 32c may function to dissipate the heat redirected from the battery cells 12 by an anisotropic thermal conductivity layer 20c coupled to the housing 30c. The anisotropic thermal conductivity layer 20c includes a first anisotropic thermal conductivity layer 20c1 and a second anisotropic thermal conductivity layer 20c2. The anisotropic thermal conductivity layers 20c1, 20c2 are disposed on either side of the battery cells 12 along a first panel 32c1 and a second panel 32c2 of the plurality of panels 32c, respectively. For example, the first anisotropic thermal conductivity layer 20c1 is coupled to the first panel 32c1, and the second anisotropic thermal conductivity layer 20c2 is coupled to the second panel 32c2.

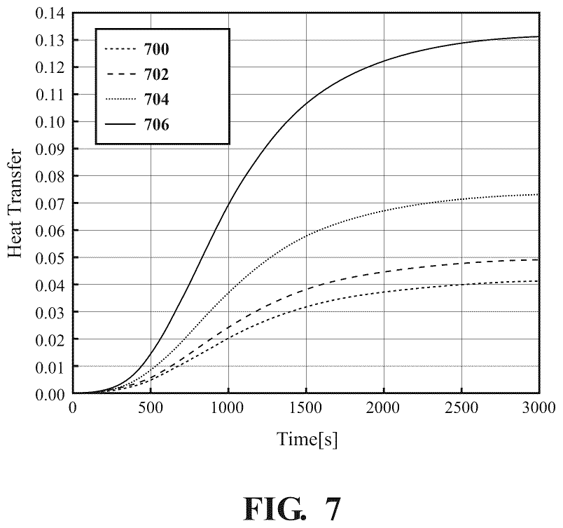

Referring to FIGS. 1-7, the performance of the battery cell group assembly 10, 10a-c may be dependent on the in-plane conductivity 22 and the through-plane conductivity 24 of the anisotropic thermal conductivity layer 20, 20a-c. For example, FIG. 7 illustrates an exemplary graph of thermal conductivity (i.e., heat transfer) of the anisotropic thermal conductivity layer 20, 20a-c over a period of time of operation of the battery cell group assembly 10, 10a-c at varying conductivities 22, 24. For example, a first heat transfer pattern 700 associated with an anisotropic thermal conductivity layer 20 having an in-plane conductivity 22 of 1500 W/mK and a through-plane conductivity 24 of eighteen (18) W/mK has less heat transfer than either of a second heat transfer pattern 702, a third heat transfer pattern 704, and a fourth heat transfer pattern 706.

The second heat transfer pattern 702 is associated with an anisotropic thermal conductivity layer 20 having an in-plane conductivity 22 of 1200 W/mK and a through-plane conductivity 24 of fifteen (15) W/mK. The third heat transfer pattern 704 is associated with an anisotropic thermal conductivity layer 20 having an in-plane conductivity 22 of 800 W/mK and a through-plane conductivity 24 of fifteen (15) W/mK. The fourth heat transfer pattern 706 is associated with an anisotropic thermal conductivity layer 20 having an in-plane conductivity 22 of 500 W/mK and a through-plane conductivity 24 of twenty-eight (28) W/mK. As illustrated in FIG. 7, the fourth heat transfer pattern 706 results in a higher degree of heat transfer over time as compared to any of the first, second, or third heat transfer patterns 700, 702, 704. As a result, the in-plane conductivity 22 of the anisotropic thermal conductivity layer 20 should be greater than approximately 500 W/mK, and the through-plane conductivity 24 of the anisotropic thermal conductivity layer 20 should be less than approximately twenty-eight (28) W/mK.

The anisotropic thermal conductivity layer 20, 20a-c advantageously redirects heat away from the battery cells 12 and the thermal insulators 14 to dissipate heat generated by the battery cells 12 and prevent a thermal propagation event. The high in-plane conductivity 22 of the anisotropic thermal conductivity layer 20, 20a-c advantageously draws heat along a length of the anisotropic thermal conductivity layer 20, 20a-c, while the low through-plane conductivity 24 minimizes heat transfer between battery cells 12. Due to the conductivity 22, 24 properties of the anisotropic thermal conductivity layer 20, 20a-c, a thickness of the thermal insulator 14 may be reduced. The thickness of the thermal insulator 14 may be reduced as a result of the heat draw of the anisotropic thermal conductivity layer 20, 20a-c away from both the battery cells 12 and the thermal insulators 14.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery cell group assembly comprising:
a cooling plate;
one or more battery cells operably coupled to the cooling plate;
one or more thermal insulators disposed between the one or more battery cells; and
an anisotropic thermal conductivity layer operably coupled to the one or more battery cells and the one or more thermal insulators, the anisotropic thermal conductivity layer being configured to redirect heat from the one or more battery cells to the cooling plate.

2. The battery cell group assembly of claim 1, wherein the anisotropic thermal conductivity layer is directly coupled with the cooling plate and indirectly coupled to the one or more battery cells.

3. The battery cell group assembly of claim 1, wherein the anisotropic thermal conductivity layer is disposed between a battery cell of the one or more battery cells and a thermal insulator of the one or more thermal insulators.

4. The battery cell group assembly of claim 3, wherein the anisotropic thermal conductivity layer is disposed around the thermal insulator.

5. The battery cell group assembly of claim 3, wherein the cooling plate is a cooling ribbon wound between adjacent battery cells of the one or more battery cells and the anisotropic thermal conductivity layer is coupled to the cooling ribbon between the adjacent battery cells.

6. The battery cell group assembly of claim 1, further including a housing having a plurality of panels, the one or more battery cells disposed within the housing and the anisotropic thermal conductivity layer coupled to the housing.

7. The battery cell group assembly of claim 6, wherein the anisotropic thermal conductivity layer includes a first anisotropic thermal conductivity layer and a second anisotropic thermal conductivity layer, the first anisotropic thermal conductivity layer coupled to a first panel of the plurality of panels of the housing and the second anisotropic thermal conductivity layer coupled to a second panel of the plurality of panels of the housing.

8. The battery cell group assembly of claim 1, wherein the anisotropic thermal conductivity layer includes an in-plane conductivity of at least 800 watts per meter kelvin (W/mK).

9. A battery cell group assembly for a vehicle, the battery cell group assembly comprising:
a cooling plate;
one or more battery cells operably coupled to the cooling plate;
one or more thermal insulators disposed between the one or more battery cells; and
a graphite layer operably coupled to the one or more battery cells, the graphite layer including an in-plane conductivity of at least 800 watts per meter kelvin and being configured to redirect heat from the one or more battery cells to the cooling plate.

10. The battery cell group assembly of claim 9, wherein the graphite layer is directly coupled with the cooling plate and indirectly coupled to the one or more battery cells.

11. The battery cell group assembly of claim 9, wherein the graphite layer is disposed between a battery cell of the one or more battery cells and a thermal insulator of the one or more thermal insulators.

12. The battery cell group assembly of claim 11, wherein the graphite layer is disposed around the thermal insulator.

13. The battery cell group assembly of claim 11, wherein the cooling plate is a cooling ribbon wound between adjacent battery cells of the one or more battery cells and the graphite layer is coupled to the cooling ribbon between the adjacent battery cells.

14. The battery cell group assembly of claim 9, further including a housing having a plurality of panels, the one or more battery cells disposed within the housing and the graphite layer coupled to the housing.

15. The battery cell group assembly of claim 14, wherein the graphite layer includes a first graphite layer and a second graphite layer, the first graphite layer coupled to a first panel of the plurality of panels of the housing and the second graphite layer coupled to a second panel of the plurality of panels of the housing.

16. The battery cell group assembly of claim 9, further including a thermal interface material coupled to the cooling plate beneath the one or more battery cells, the graphite layer being disposed between the thermal interface material and the cooling plate.

17. A battery cell group assembly for a vehicle, the battery cell group assembly comprising:
a cooling plate;
one or more battery cells operably coupled to the cooling plate;
a thermal interface material coupled to the cooling plate beneath the one or more battery cells;
one or more thermal insulators disposed between the one or more battery cells and operably coupled to the one or more battery cells and the thermal interface material; and
a graphite layer operably coupled to the thermal interface material and the cooling plate and indirectly operably coupled to the one or more battery cells, the graphite layer including an in-plane conductivity of at least 800 watts per meter kelvin (W/mK) and being configured to redirect heat from the one or more battery cells to the cooling plate.

18. The battery cell group assembly of claim 17, wherein the in-plane conductivity of the graphite layer is approximately 1200 W/mK.

19. The battery cell group assembly of claim 17, wherein the in-plane conductivity of the graphite layer is approximately 1500 W/mK.

20. The battery cell group assembly of claim 17, wherein the graphite layer has a through-plane conductivity of less than twenty (20) W/mK.
